(19) United States
(12) Patent Application Publication
(10) Pub. No.: US 2003/0146996 A1
(43) Pub. Date: Aug. 7, 2003

(54) Imaging apparatus

(76) Inventor: Hiroyuki Ide, Osaka (JP)

Correspondence Address: Gerald T. Bodner, Esq., BODNER & O'ROURKE, LLP, Suite 108, 425 Broad Hollow Road, Melville, NY, 11747, US

(21) Appl. No.: 10/355,905

(22) Filed: Jan. 31, 2003

(30) Foreign Application Priority Data
Feb. 6, 2002 (JP) 2002-29779

(51) Int. Cl. H04N 5/335

(52) U.S. Cl. 348/323; 348/273

(57) ABSTRACT

An imaging apparatus includes 1280 of vertical transfer registers which are respectively assigned to 1280 of vertical lines. Each vertical line is formed by light receiving elements being successive in a vertical direction. Electric charges generated at 640 of the odd-numbered vertical lines among the 1280 of vertical lines are applied to one of horizontal transfer registers, and electric charges generated at 640 of the even-numbered vertical lines are applied to the other of the horizontal transfer registers. The electric charges are output from a CCD imager via these horizontal transfer registers.

### BACKGROUND OF THE INVENTION

1. Field of the Invention

The present invention relates to an imaging apparatus applied to a digital camera, for example. More specifically, the present invention relates to an imaging apparatus for capturing an optical image of an object by an image sensor of an interline transfer type.

2. Description of the Prior Art

There is a resolution as one of elements of determining image quality of a photographed object image. For a low resolution, a detailed description cannot be done and therefore, satisfactory image quality cannot be obtained. On the contrary thereto, for a high resolution, a fine representation can be realized and therefore, a high-quality image can be obtained.

However, if the number of pixels of an image sensor is increased for the purpose of improving the image quality, it takes a long time for reading one frame of electric charges. That is, as the number of pixels of the image sensors increases, a shutter interval becomes long.

### SUMMARY OF THE INVENTION

Therefore, it is a primary object of the present invention to provide an imaging apparatus capable of shortening a time required to read electrical charges.

An imaging apparatus according to the present invention comprises: a plurality of light receiving elements for generating electric charges by photoelectric conversion; L of vertical transfer registers which are respectively assigned to L of vertical lines each of which is formed by the light receiving elements being successive in a vertical direction; a first horizontal transfer register to which electric charges generated by M of vertical lines among the L of vertical lines are applied; and a second horizontal transfer register to which electric charges generated in other N of vertical lines among the L of vertical lines are applied.

The L of vertical transfer registers are respectively assigned to the L of vertical lines formed by the plurality of light receiving elements. The electric charges generated in the M of vertical lines among the L of vertical lines are applied to the first horizontal transfer register, and the electric charges generated in other N of vertical lines among the L of vertical lines are applied to the second horizontal transfer register. The electric charges are output from the imaging apparatus via the first horizontal transfer register or the second horizontal transfer register.

Transferring destination of the electric charge is divided into the first horizontal transfer register and the second horizontal transfer register, and therefore, it is possible to shorten a time period required to read the electric charges.

In a case a color filter formed with a plurality of color elements respectively corresponding to the plurality of light receiving elements is provided, colors of color elements assigned to M of vertical lines are different from colors of color elements assigned to N of vertical lines. Herein, the electric charges output from the first horizontal transfer register and the electric charges output from the second horizontal transfer register are never corresponding to the same color elements, and therefore, a strict level adjustment after outputting is unnecessary.

Where the first horizontal transfer register is placed at one end of the vertical transfer register in the longitudinal direction, and the second horizontal transfer register is placed at the other end of the vertical transfer register in the longitudinal direction, though it is required to reverse the transfer directions with each other, a transfer distance is equal, and therefore, it is possible to make a timing control of the vertical transfer.

The above described objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing one embodiment of the present invention;

FIG. 2 is an illustrative view showing one example of a color filter configuration;

FIG. 3 is an illustrative view showing an overall configuration of a CCD imager;

FIG. 4 is an illustrative view showing a part of a configuration of the CCD imager;

FIG. 5 is a block diagram showing one example of a configuration of a timing generator;

FIG. 6(A) is an illustrative view showing one example of a transfer state of electric charges read in odd-numbered vertical pixel lines;

FIG. 6(B) is a waveform chart showing one example of a driving pulse;

FIG. 6(C) is an illustrative view showing one example of a transfer state of electric charges read in even-numbered vertical pixel lines;

FIG. 7(A) is an illustrative view showing another example of a transfer state of the electric charges read in the odd-numbered vertical pixel lines;

FIG. 7(B) is a waveform chart showing another example of the driving pulse;

FIG. 7(C) is an illustrative view showing another example of a transfer state of the electric charges read in the even-numbered vertical pixel lines;

FIG. 8(A) is an illustrative view showing the other example of a transfer state of the electric charges read in the odd-numbered vertical pixel lines;

FIG. 8(B) is a waveform chart showing the other example of the driving pulse;

FIG. 8(C) is an illustrative view showing the other example of a transfer state of the electric charges read in the even-numbered vertical pixel lines;

FIG. 9 is an illustrative view showing a part of configuration of a CCD imager applied to another embodiment of the present invention;

FIG. 10(A) is an illustrative view showing one example of a transfer state of the electric charges read from the odd-numbered vertical pixel lines;

FIG. 10(B) is a waveform chart showing one example of the driving pulse;

FIG. 10(C) is an illustrative view showing one example of a transfer state of the electric charge read from the even-numbered vertical pixel lines;

FIG. 11(A) is an illustrative view showing another example of a transfer state of the electric charge read from the odd-numbered vertical pixel lines;

FIG. 11(B) is a waveform chart showing another example of the driving pulse;

FIG. 11(C) is an illustrative view showing another example of a transfer state of the electric charges read from the even-numbered vertical pixel lines;

FIG. 12(A) is an illustrative view showing the other example of a transfer state of the electric charges read from the odd-numbered vertical pixel lines;

FIG. 12(B) is a waveform chart showing the other example of the driving pulse; and

FIG. 12(C) is an illustrative view showing the other example of a transfer state of the electric charges read from the even-numbered vertical pixel lines.

### DETAILED DESCRIPTION OF THE PREFERRED EMBODIMENTS

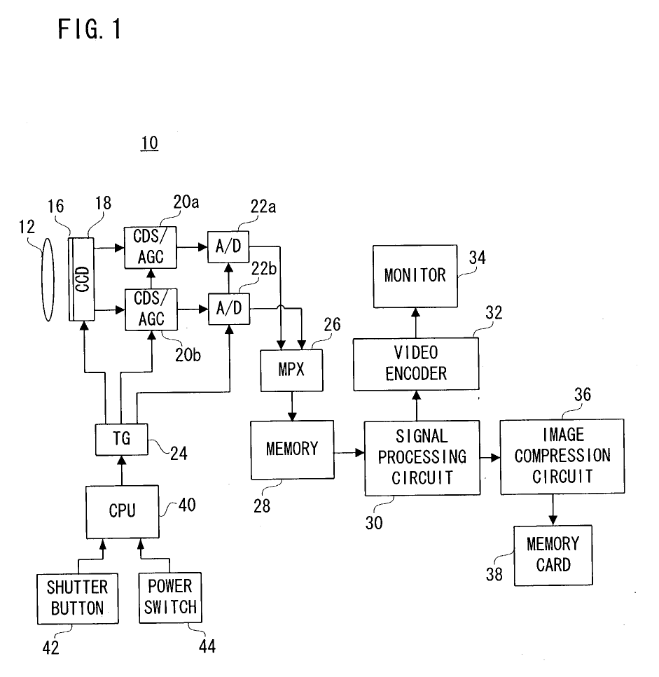

Referring to FIG. 1, a digital camera 10 of this embodiment includes an optical lens 12 and a complementary color filter 16. An optical image of an object is illuminated on a light-receiving surface of a CCD imager 18 through these members.

When a power switch 44 is turned on, a CPU 40 instructs a timing generator (TG) 24 to perform thin-out reading. The TG 24 drives the CCD imager 18 by a thin-out reading manner. A raw image signal (electric charge) having a low resolution subjected to a vertical thinning-out is read every 1/30 second from the CCD imager 18. As described later, the CCD imager 18 has a first output channel and a second output channel, and a half raw image signal belongs to odd-numbered pixel lines is output from the first output channel, and a half raw image signal belongs to even-numbered pixel lines is output from the second output channel.

The half raw image signal output from the first output channel is applied to a multiplexer 26 via a CDS/AGC circuit 20a and an A/D converter 22a, and the half raw image signal output from the second output channel is applied to the multiplexer 26 via a CDS/AGC circuit 20b and an A/D converter 22b. The multiplexer 26 alternately selects the applied half raw image signals every one pixel so as to write to a memory 28. Herein, by allocating a writing address of the memory 28 from a top for a second output side and allocating a writing address from an end for a first output side, a raw image is created on the memory 28.

It is noted that the processing speed after the multiplexer 26 is twice as fast as before, and processing of the raw image signal output from the multiplexer 26 is never interfered.

A signal processing circuit 30 reads the raw image signal from the memory 28 and performs a horizontal thinning-out, color separation, RGB conversion, a white balance adjustment, YUV conversion and etc. on the read raw image signal so as to generate YUV signal having a low resolution. The generated low resolution YUV signal is converted to a composite image signal by a video encoder 32, and the converted composite image signal is applied to a display 34. Consequently, a real-time through image of the object (through image) is displayed on the display 34.

When a shutter button 42 is operated, the CPU 40 instructs the TG 24 to read all the pixels. The TG 24 drives the CCD imager 18 by an all the pixels reading manner over one frame period. A raw image signal having a high resolution is read from the CCD imager 18 by an interlace scan scheme. At this time also, the half raw image signal belongs to the odd pixel line is output from the first output channel, and the half raw image signal belongs to the even pixel line is output from the second output channel. The half raw image signals output from the first output channel and the second output channel are written to the memory 28 through a multiplexing process by the multiplexer 26. Since the all pixels reading is performed in the interlace scan scheme, an odd field raw image signal and an even field raw image signal are individually stored in the memory 28.

The signal processing circuit 26 alternately reads a raw image signal of each field stored in the memory 28 line by line. Therefore, an interlace scan signal is converted to a progressive scan signal. The signal processing circuit 26 succeedingly performs the processes other than the horizontal thinning-out on the read raw image signal, and applies a high-resolution YUV signal thus generated to an image compression circuit 36. The high resolution YUV signal is subjected to JPEG compression by the image compression circuit 36 and recorded onto a memory card 38.

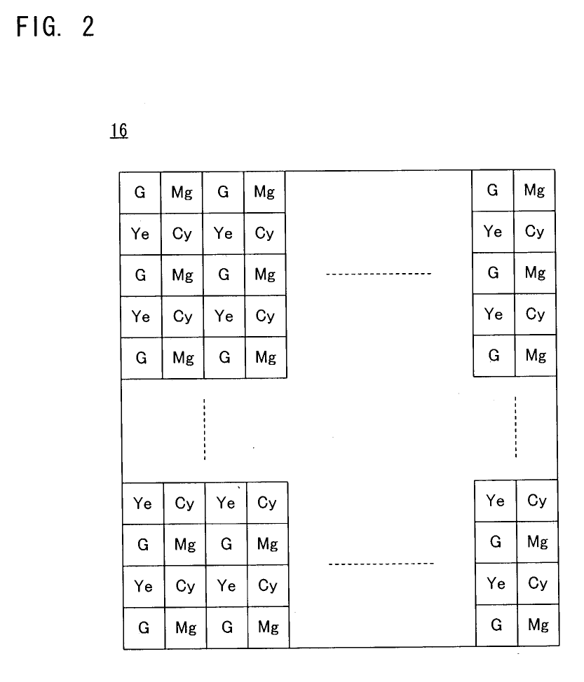

The complementary color filter 16 includes color elements of Ye, Cy, Mg and G as shown in FIG. 2. Viewing each color element line extending in a horizontal direction, color elements of G and Mg are placed pixel by pixel at an odd-numbered color element line, and color elements of Ye and Cy are alternately placed pixel by pixel at an even-numbered color elements line. That is, the complementary color filter 16 is formed with a plurality of matrices (color blocks) with two pixels in a horizontal direction and two pixels in a vertical direction.

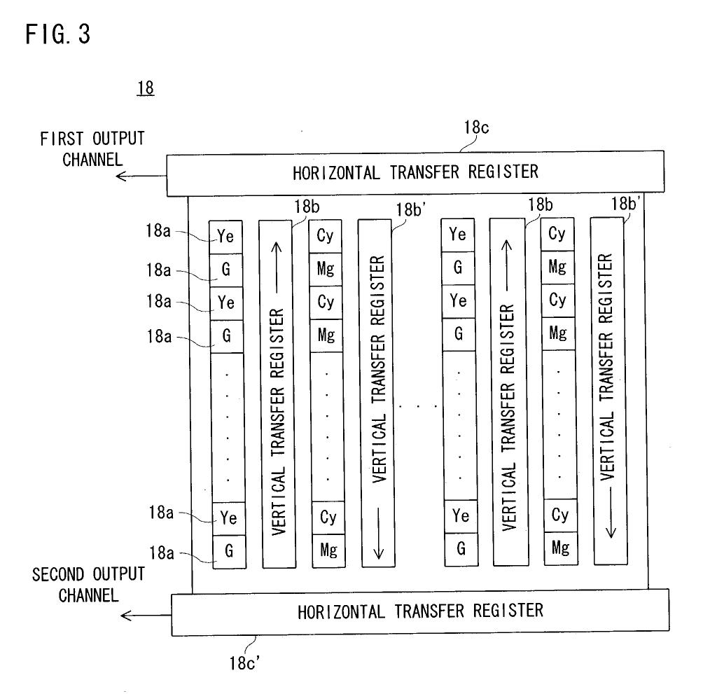

Referring to FIG. 3, the CCD imager 18 is an image sensor of an interline transfer type. The light-receiving surface is formed with a plurality of light receiving elements (pixels) 18a. The light receiving elements 18a of 1280 are aligned in a horizontal direction of the light-receiving surface, and the light receiving elements of 960 are aligned in a vertical direction of the light-receiving surface. Such the plurality of light receiving elements 18a are respectively corresponding to the plurality of color elements forming a complementary color filter. Accordingly, one vertical pixel line is formed by the light receiving elements 18a assigned to color elements forming one color element line.

Vertical transfer registers 18b are assigned to the odd-numbered vertical pixel lines, and vertical transfer registers 18b′ are assigned to the even-numbered vertical pixel lines. The light receiving elements 18a of 1280 are aligned in a horizontal direction, and therefore, the vertical transfer registers 18b of 640 and the vertical transfer registers 18b′ of 640 are aligned. Electric charge (pixel signal) corresponding to any one of Ye, Cy, Mg and G is generated by photoelectric conversion in each light-receiving element 18a. The generated electric charge is read to the vertical transfer register 18b or 18b′ and then, transferred to a vertical direction. At this time, the electric charge read to the vertical transfer register 18b is transferred to an upper direction, and the electric charge read to the vertical transfer register 18b′ is transferred to a lower direction.

A horizontal transfer register 18c is placed at the upper ends of the vertical transfer registers 18b and 18b′, and a horizontal transfer register 18c′ is placed at the lower ends of the vertical transfer registers 18b and 18b′. The electric charge transferred to the upper end of the vertical transfer register 18b is transferred to a horizontal direction by the horizontal transfer register 18c, and the electric charge transferred to the lower end of the vertical transfer register 18b′ is transferred to the horizontal direction by the horizontal transfer register 18c′. The electric charge corresponding to the color element of Ye or G is output from the first output channel, and the electric charge corresponding to the color element of Cy or Mg is output from the second output channel.

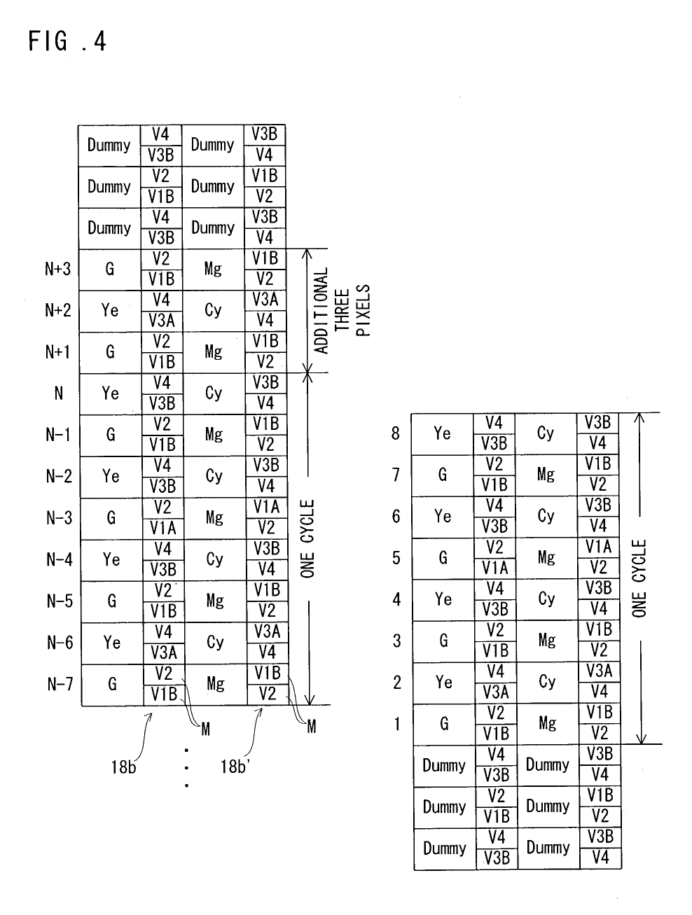

As shown in FIG. 4, the vertical transfer register 18b or 18b′ is formed by a plurality of metals M. Two metals M are assigned to each light receiving element 18a, and each metal M is applied with any one of driving pulses V1A, V1B, V2, V3A, V3B and V4 output from the TG 24. Paying attention to successive 8 pixels in a vertical direction, the driving pulses V1B and V2 are applied to two metals M assigned to a G/Mg pixel of a first numbered-line from the bottom (first line), the driving pulses V3A and V4 are applied to two metals M assigned to a Ye/Cy pixel of a second numbered-line from the bottom (second line), the driving pulses V1B and V2 are applied to two metals M assigned to a G/Mg pixel from the bottom (third line), and the driving pulses V3B and V4 are applied to two metals M assigned to a Ye/Cy pixel of a fourth numbered-line from the bottom (fourth line).

Furthermore, the driving pulses V1A and V2 are applied to two metals M assigned to a G/Mg pixel of a fifth numbered-line from the bottom (fifth line), the driving pulses V3B and V4 are applied to two metals M assigned to a Ye/Cy pixel of a sixth numbered-line from the bottom (sixth line), the driving pulses V1B and V2 are applied to two metals M assigned to a G/Mg pixel of a seventh numbered-line from the bottom (seventh line), and the driving pulses V3B and V4 are applied to two metals M assigned to a Ye/Cy pixel of a eighth line from the bottom (eighth line).

It is noted that as shown in FIG. 4, an order of driving pulses to be applied to two metals which is assigned to each of pixels is inverted between the vertical transfer registers 18b and 18b′ for each other.

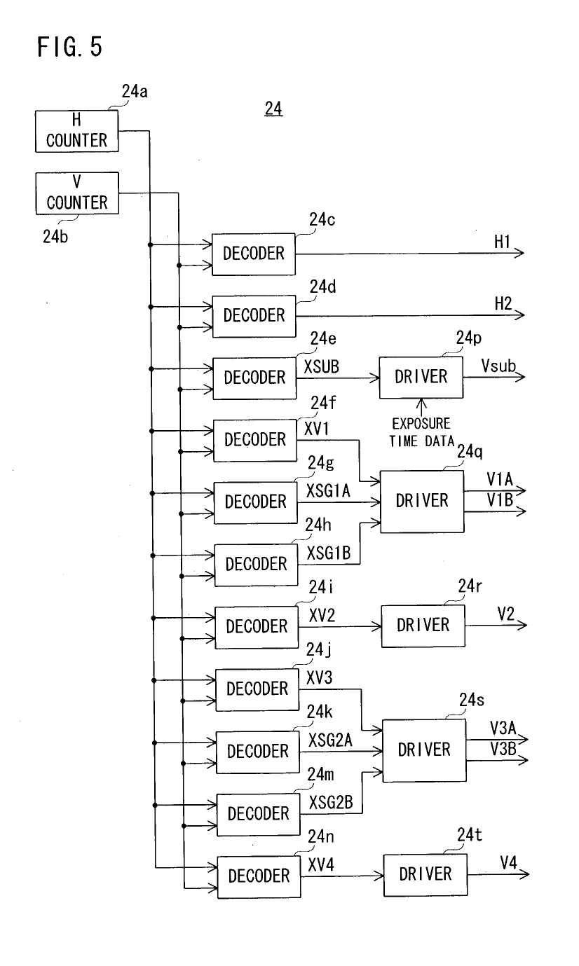

The TG 24 is specifically constituted as shown in FIG. 5. It is noted that FIG. 5 only shows a circuit relating to driving of the CCD imager 18. A count value of an H counter 24a (horizontal count value) is incremented in response to a pixel clock, and reset in response to a horizontal synchronization signal. On the other hand, a count value of a V counter 24b (vertical count value) is incremented in response to the horizontal synchronization signal and reset in response to a vertical synchronization signal. Both the horizontal count value and the vertical count value are applied to decoders 24c to 24n.

The decoders 24c and 24d respectively generate driving pulses H1 and H2 on the basis of the horizontal count value and the vertical count value. Each of the horizontal transfer registers 18c and 18c′ is driven by the driving pulses H1 and H2. The decoder 24e generates a timing pulse XSUB on the basis of the horizontal count value and the vertical count value, and a driver 24p generates a charge sweep pulse Vsub on the basis of the timing pulse XSUB from the decoder 24e and exposure time period data from the CPU 40. The electronic shutter is realized by the charge sweep pulse Vsub.

The decoders 24f to 24h respectively generate timing pulses XV1, XSG1A and XSG1B on the basis of the horizontal count value and the vertical count value. A driver 24q generates driving pulses V1A and V1B on the basis of such the timing pulses XV1, XSG1A and XSG1B. The decoder 24i generates a timing pulse XV2 on the basis of the horizontal count value and the vertical count value, and a driver 24r generates a driving pulse V2 on the basis of the timing pulse XV2.

The decoders 24j to 24m respectively generate timing pulses XV3, XSG2A and XSG2B on the basis of the horizontal count value and the vertical count value. A driver 24s generates driving pulses V3A and V3B on the basis of such the timing pulses XV3, XSG2A and XSG2B. The decoder 24n generates a timing pulse XV4 on the basis of the horizontal count value and the vertical count value, and a driver 24t generates a driving pulse V4 on the basis of the timing pulse XV4.

Waveforms of the driving pulses V1A and V1B are coincident with each other when the CCD imager 16 is driven by the all pixels reading manner while they are different from each other when the CCD imager 16 is driven by the thin-out reading manner. It is necessary to change a voltage level to a plus level in order to read the electric charge from the light receiving element 18a to be applied, and the driving pulses V1A and V1B rise to a plus level at the same timing in the all pixel reading manner. On the contrary thereto, it is not necessary to read electric charges from all the light receiving elements 18a in the thin-out reading manner, and therefore, only the pulse V1A rises to the plus level. As shown in FIG. 4, the driving pulses V1A are applied to pixels in the fifth line, and the driving pulses V1B are applied to pixels in the first, third and seventh lines. Therefore, the electric charge is read from the pixels in only the fifth line among the above-described 8 lines in the thin-out reading manner.

The waveforms of the driving pulses V3A and V3B are also coincident with each other in the all the pixels reading manner while they are different from each other in the thin-out reading manner. As descried above, the driving pulses V3A and V3B rise to a plus level at the same timing in the all the pixels reading manner while only the driving pulse V3A rises to a plus level in the thin-out reading manner. According to FIG. 4, the driving pulses V3A are applied to pixels in the second line, and the driving pulses V3B are applied to the fourth, sixth and eighth lines. Therefore, the electric charge is read from the pixels in only the second line among the above-described 8 lines in the thin-out reading manner.

It is noted that rising of the driving pulses V1A and V1B to the plus level is based on the timing pulse XSG1A output from the decoder 24g. Furthermore, rising of the driving pulses V3A and V3B to the plus level is based on the timing pulse XSG2A output from the decoder 24k.

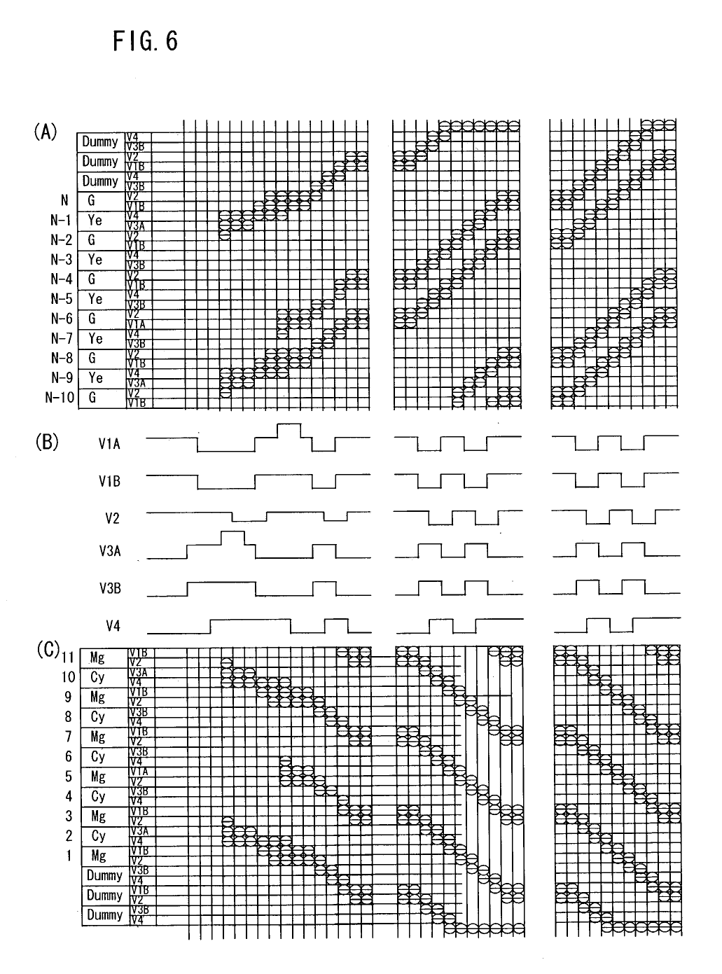

An operation of the CCD imager 18 at a time of performing the thin-out reading will be described in detail with referring to FIG. 6(A) to FIG. 6(C). FIG. 6(A) shows a transfer process of the electric charge generated at the odd-numbered vertical pixel lines, FIG. 6(B) shows waveforms of driving pulses V1A, V1B, V2, V3A, V3B and V4, and FIG. 6(C) shows a transfer process of the electric charge generated at the even-numbered vertical pixel lines.

The driving pulses V1A and V3A rise to a plus level at a predetermined timing, and whereby, the electric charges are read from the light receiving elements 18a in the fifth line and the second line. At a time the driving pulse V1A is risen, the driving pulses V2 and V4 take a zero level. Therefore, the electric charges read from the light receiving elements 18a in the fifth line are accumulated in two metals M assigned to the fifth line and one metal M assigned to the sixth line. Furthermore, the electric charges read from the light receiving elements 18a in the second line are accumulated to two metals M assigned to the second line and one metal M assigned to the third line.

After completion of reading the electric charges, all of the driving pulses V1A, V1B, V2, V3A, V3B and V4 are changed between the zero level and a minus level. The electric charges read from the second and fifth lines are transferred to the vertical direction without being mixed with each other due to such the change of the voltage level. Herein, the electric charges read from the odd-numbered vertical pixel lines are transferred to the horizontal transfer register 18c, and the electric charges read from the even-numbered vertical pixel lines are transferred to the horizontal transfer register 18c′. The electric charges reached to the horizontal transfer registers 18c and 18c′ are transferred to the horizontal direction by the driving pulses H1 and H2, and then output from the CCD imager 18.

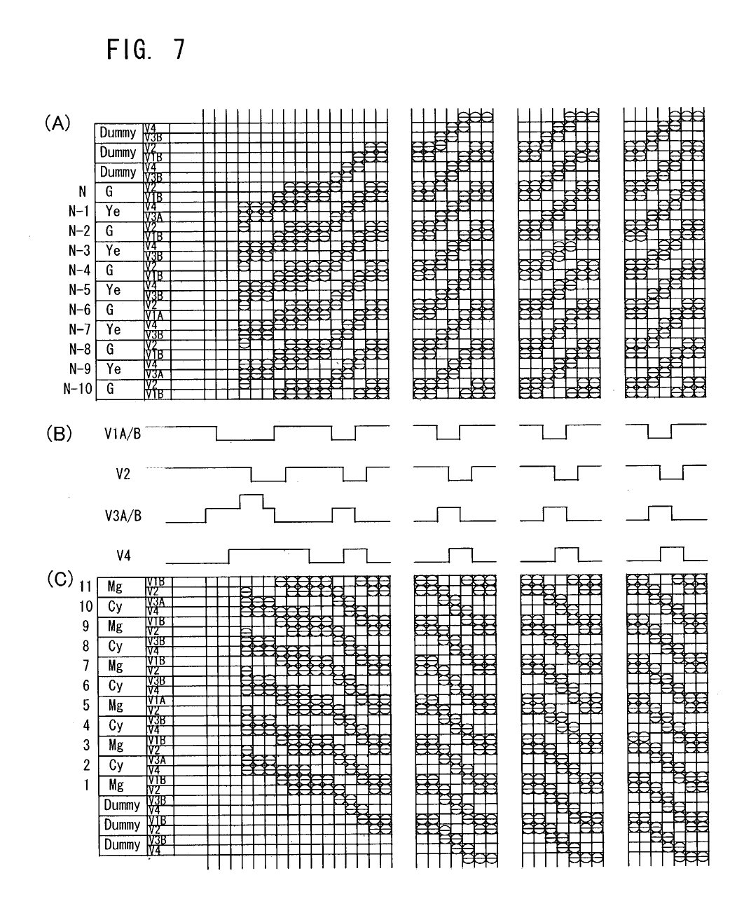

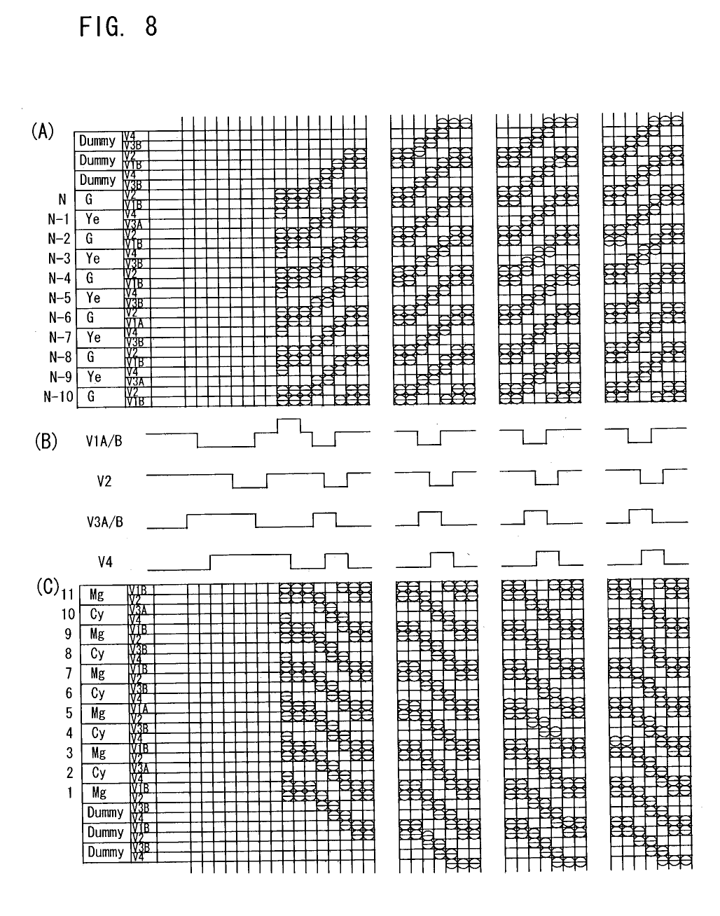

An operation of the CCD imager 18 at a time of reading all the pixels will be described in detail with referring to FIG. 7(A) to FIG. 7(C) and FIG. 8(A) to FIG. 8(C). FIG. 7(A) shows a transfer process of the electric charges generated at the odd-numbered vertical pixel lines in an odd field, FIG. 7(B) shows waveforms of the driving pulses V1A, V1B, V2, V3A, V3B and V4, and FIG. 7(C) shows a transfer process of the electric charges generated at the even-numbered vertical pixel lines in the odd field. Furthermore, FIG. 8(A) shows a transfer process of the electric charges generated at the odd-numbered vertical pixel lines in an even field, FIG. 8(B) shows waveforms of the driving pulses V1A, V1B, V2, V3A, V3B and V4, and FIG. 8(C) shows a transfer process of the electric charges generated at the even-numbered vertical pixel lines in the even field.

Referring to FIG. 7(A) to FIG. 7(C), in the odd field, the driving pulses V3A and V3B rise to a plus level at a predetermined timing, and the electric charges are read from the light-receiving elements 18a in the second, the fourth, the sixth and the eighth lines. Herein, the driving pulses V2 and V4 show a zero level, and the electric charges read from the respective light receiving elements 18a are accumulated in two metals M assigned to the second line, one metal M assigned to the third line, two metals M assigned to the fourth line, one metal M assigned to the fifth line, two metals M assigned to the sixth line, one metal M assigned to the seventh line, two metals M assigned to the eighth line and one metal M assigned to the first line.

After completion of reading the electric charges, all the driving pulses V1A, V1B, V2, V3A, V3B and V4 are changed between the zero level and the minus level. The electric charges read from the odd-numbered vertical pixel lines are transferred toward the horizontal transfer register 18c, and the electric charges read from the even-numbered vertical pixel lines are transferred toward the horizontal transfer register 18c′. The electric charges reached to the horizontal transfer registers 18c and 18c′ are transferred to the horizontal direction by the driving pulses H1 and H2 and then, be output form the CCD imager 18.

Referring to FIG. 8(A) to FIG. 8(C), the driving pulses V1A and V1B rise to a plus level at a predetermined timing in the even field, and the electric charges are read from the light-receiving elements 18a in the first, third, fifth and seventh lines. Also at this time, the driving pulses V2 and V4 show the zero level, and the electric charges read from the respective light receiving elements 18a are accumulated in two metals M assigned to the first line, one metal M assigned to the second line, two metals assigned to the third line, one metal M assigned to the fourth line, two metals M assigned to the fifth line, one metal M assigned to the sixth line, two metals M assigned to the seventh line and one metal M assigned to the eighth line.

After completion of reading the eclectic charges, the driving pulses V1A, V1B, V2, V3A, V3B and V4 are changed between the zero level and the minus level. The electric charges read from the odd-numbered vertical pixel lines are transferred to an upper direction, and the electric charges read from the even-numbered vertical pixel lines are transferred to a lower direction. The electric charges reached to the horizontal transfer registers 18c and 18c′ are transferred to the horizontal direction by the driving pulses H1 and H2, and then output from the CCD imager 18.

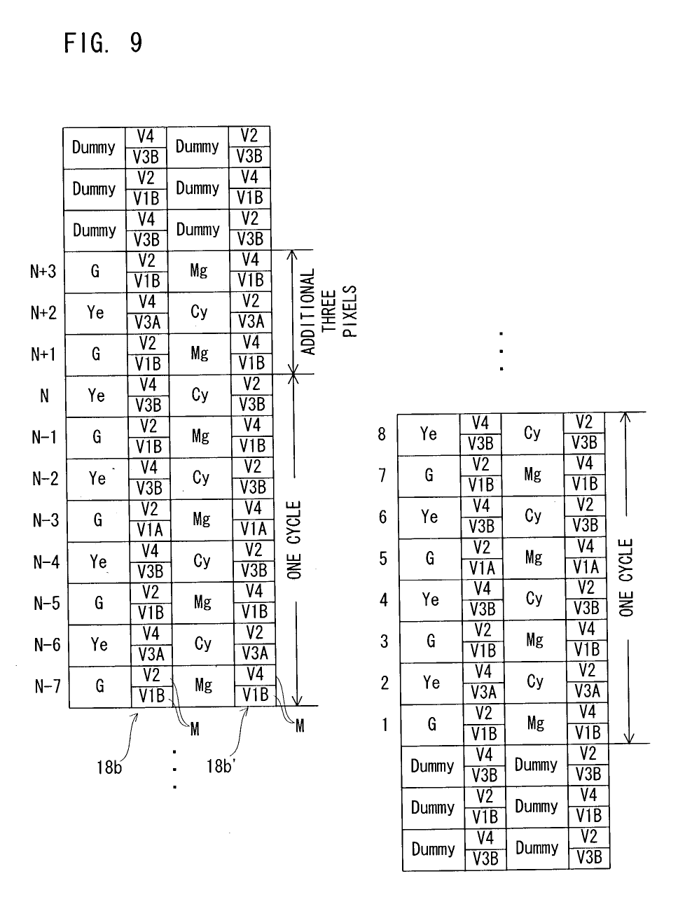

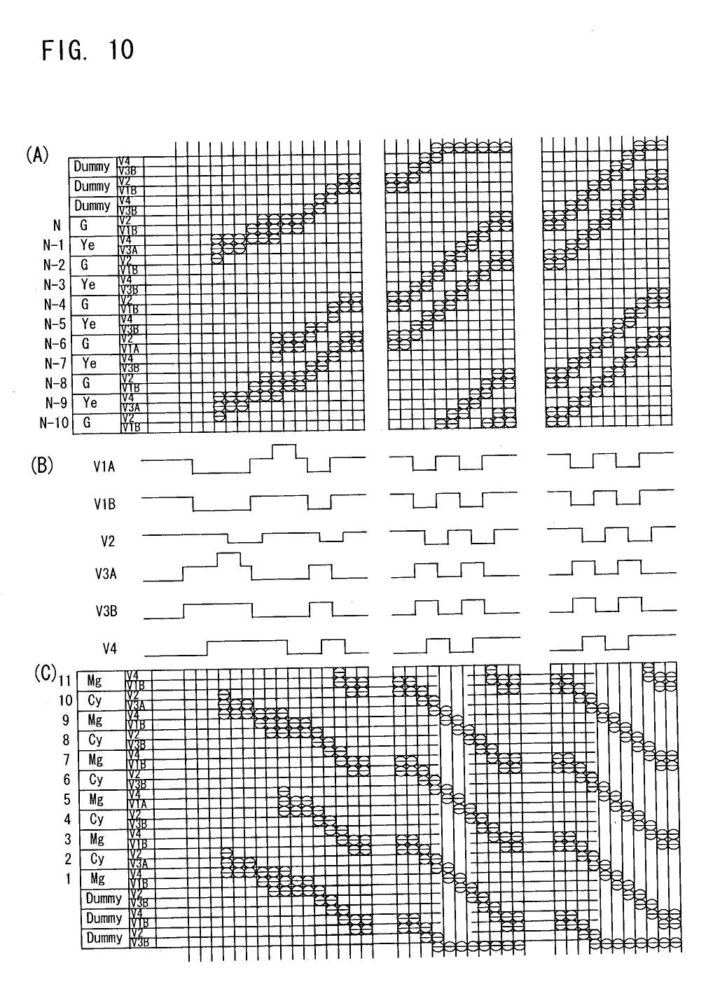

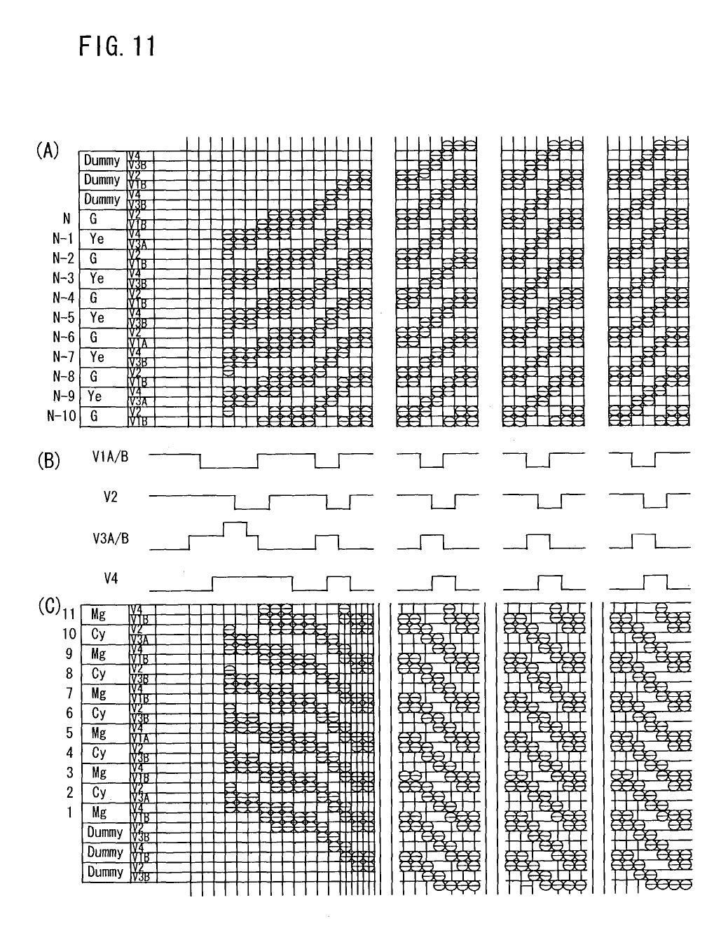

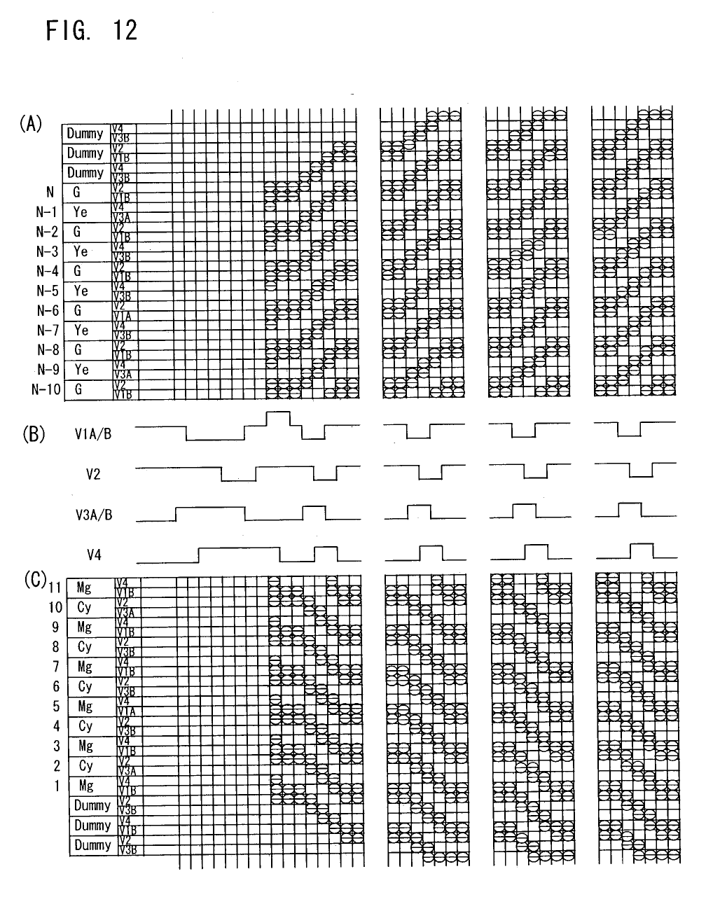

The digital camera 10 according to another embodiment is the same as the FIG. 1 embodiment except that the CCD imager 18 is constituted as shown in FIG. 9 and the electric charges generated in the respective light receiving elements 18a are transferred as shown in FIG. 10(A) to FIG. 10(C), FIG. 11(A) to FIG. 11(C) and FIG. 12(A) to FIG. 12(C), and therefore, a duplicated description will be omitted as to the common part.

Referring to FIG. 9, the vertical transfer register 18b or 18b′ is also constituted by a plurality of metals M, two metals M are assigned to each light receiving element 18a, and each metal M is applied with any one of driving pulses V1A, V1B, V2, V3A, V3B and V4 output from the TG 24. Furthermore, each metal M forming the vertical transfer register 18b is applied with driving pulse V1A, V1B, V2, V3A, V3B or V4 as shown in FIG. 1 embodiment. It is noted that each metal M forming the vertical transfer register 18b′ is applied with the driving pulse V1A, V1B, V2, V3A, V3B or V4 in a following manner.

The driving pulses V4 and V1B are applied to two metals M assigned to an Mg pixel in the first line, the driving pulses V2 and V3A are applied to two metals M assigned to a Cy pixel in the second line, the driving pulses V4 and V1B are applied to two metals assigned to the Mg pixel in the third line, and the driving pulses V2 and V3B are applied to the metal M assigned to a Cy pixel in the fourth line.

Furthermore, the driving pulses V4 and V1A are applied to two metals M assigned to an Mg pixel in the fifth line, the driving pulses V2 and V3B are applied to two metals M assigned to a Cy pixel in the sixth line, the driving pulses V4 and V1B are applied to metals M assigned to an Mg pixel in the seventh line, and the driving pulses V2 and V3B are applied to metals M assigned to a Cy pixel in the eighth line.

An operation of the CCD imager 18 at a time of performing thin-out reading is described with referring to FIG. 10(A) to FIG. 10(C). It is noted that FIG. 10(A) shows a transfer process of the electric charges generated in the odd-numbered vertical pixel lines, FIG. 10(B) shows waveform charts showing the driving pulses V1A, V1B, V2, V3A, V3B and V4, and FIG. 10(C) shows a transfer process of the electric charges generated in the even-numbered vertical pixel lines.

The driving pulses V1A and V3A rise to a plus level at a predetermined timing and whereby, electric charges are read from the light receiving elements 18a in the fifth and second lines. At a time the driving pulse V1A is risen, the driving pulses V2 and V4 take a zero level. Therefore, the electric charges read from the light receiving element 18a in the fifth line are accumulated in two metals M assigned to the fifth line and one metal M assigned to the fourth line, and the electric charges read from the light receiving element 18a in the second line are accumulated in two metals M assigned to the second line and one metal M assigned to the first line.

After completion of reading the electric charges, the driving pulses V1A, V1B, V2, V3A, V3B and V4 are changed between the zero level and the minus level. The electric charges read from the second line and fifth line are transferred to the vertical direction without being mixed with each other due to the change of the voltage level. The electric charges read from the odd-numbered pixel lines are transferred to the horizontal transfer register 18c, and the electric charges read from the even-numbered vertical pixel lines are transferred to the horizontal transfer register 18c′. The electric charges reached to the horizontal transfer registers 18c and 18c′ are transferred to the horizontal direction by the driving pulses H1 and H2 and output from the CCD imager 18.

An operation of the CCD imager 18 at a time of reading all the pixels is described with referring to FIG. 11(A) to FIG. 11(C) and FIG. 12(A) to FIG. 12(C). It is noted that FIG. 11(A) shows a transfer process of the electric charges generated in the odd-numbered vertical pixel lines in the odd field, FIG. 11(B) shows waveforms showing the driving pulse V1A, V1B, V2, V3A, V3B and V4, and FIG. 11(C) shows a transfer process of the electric charges generated in the even-numbered vertical pixel lines in the odd field. Furthermore, FIG. 12(A) shows a transfer process of the electric charges generated in the odd-numbered vertical pixel lines in the even field, FIG. 12(B) shows waveforms of the driving pulses V1A, V1B, V2, V3A, V3B and V4, and FIG. 12(C) shows a transfer process of the electric charges generated in the even-numbered vertical pixel lines in the even field.

With referring to FIG. 11(A) to FIG. 11(C), in the odd field the driving pulses V3A and V3B rise to a plus level at a predetermined timing, and electric charges are read from the light receiving elements 18a in the second, fourth, sixth and eighth lines. The driving pulses V2 and V4 show a zero level at this time, and therefore, the electric charges read from the respective light receiving elements 18a are accumulated in two metals M assigned to the second line, one metal M assigned to the first line, two metals M assigned to the fourth line, one metal M assigned to the third line, two metals M assigned to the sixth line, one metal M assigned to the fifth line, two metals M assigned to the eighth line and one metal M assigned to the seventh line.

After completion of reading the electric charges, the driving pulses V1A, V1B, V2, V3A, V3B and V4 are changed between the zero level and the minus level. Therefore, the electric charges read from the odd-numbered vertical pixel lines are transferred toward the horizontal transfer register 18c, and the electric charges read from the even-numbered vertical pixel lines are transferred toward the horizontal transfer register 18c′. The electric charges reached to the horizontal transfer registers 18c and 18c′ are transferred to the horizontal direction by the driving pulses H1 and H2, and then output from the CCD imager 18.

With referring to FIG. 12(A) to FIG. 12(C), in the even field, the driving pulses V1A and VB rise to a plus level at a predetermined timing, and electric charges are read from the light receiving elements 18a in the first, third, fifth and seventh lines. Also at this time, the driving pulse V2 and V4 show the zero level, and the electric charges read from the respective light receiving elements 18a are accumulated in two metals M assigned to the first line, one metal M assigned to the eighth line, two metals M assigned to the third line, one metal M assigned to the second line, two metals M assigned to the fifth line, one metal M assigned to the fourth line, two metals M assigned to the seventh line and one metal M assigned to the sixth line.

After completion of reading the electric charges, the driving pulses V1A, V1B, V2, V3A, V3B and V4 are changed between the zero level and the minus level, and therefore, the electric charges read from the odd-numbered vertical pixel lines are transferred to the upper direction, and the electric charges read from the even-numbered vertical pixel lines are transferred to the lower direction. The electric charges reached to the horizontal transfer registers 18c and 18c′ are transferred to the horizontal direction by the driving pulses H1 and H2, and then output from the CCD imager 18.

As can be understood from the above-description, the vertical transfer registers 18b and 18b′ of 1280 are respectively assigned to the vertical lines of 1280 each of which is formed by the light receiving elements 18a being successive in a vertical direction. The electric charges generated at the vertical lines of 640 belong to the odd-numbered lines among the vertical lines of 1280 are applied to the horizontal transfer register 18c, and the electric charges generated at the vertical lines of 640 belong to the even-numbered lines are applied to the horizontal transfer register 18c′. The electric charges are output from the CCD imager 18 via the horizontal transfer registers 18c or 18c′. Transferring destination of the electric charges is divided into the horizontal transfer register 18c and the horizontal transfer register 18c′, and whereby, it is possible to shorten a time required to read the electric charges.

Furthermore, the light-receiving surface of the CCD imager 18 is covered with the complementary color filter 16. The color elements 18a of Ye and G are assigned to the light receiving elements 18a forming the odd-numbered vertical lines while the color elements of Mg and Cy are assigned to the light receiving elements 18a forming the even-numbered vertical lines. Therefore, the color elements corresponding to the electric charges output from the horizontal transfer register 18c are never coincident with the color elements corresponding to the electric charges output from the horizontal transfer register 18c′, and therefore, there is no need to perform a strict level adjustment (adjustment for conforming the signal level with each other) by the CDS/AGC circuits 20a and 20b.

In addition, the horizontal transfer register 18c is placed at one end of the vertical transfer registers 18b and 18b′ in the longitudinal direction, and the horizontal transfer register 18c′ is placed at the other end of the vertical transfer registers 18b and 18b′ in the longitudinal direction, and therefore, though it is necessary to reverse the transfer directions with each other, a transfer distance is equal. Therefore, it is possible to perform timing control of the vertical transfer.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An imaging apparatus, comprising:
a plurality of light receiving elements for generating electric charges by photoelectric conversion;
L of vertical transfer registers respectively assigned to L of vertical lines each of which is formed by the light receiving elements being successive in a vertical direction;
a first horizontal transfer register to which electric charges generated in M of vertical lines among said L of vertical lines are applied; and
a second horizontal transfer register to which electric charges generated in other N of vertical lines among said L of vertical lines are applied.

2. An imaging apparatus according to claim 1, further comprising a color filter formed with a plurality of color elements respectively corresponding to said plurality of light receiving elements, wherein colors of color elements assigned to said M of vertical lines are different from colors of color elements assigned to said N of vertical lines.

3. An imaging apparatus according to claim 1, wherein said first horizontal transfer register is placed at one ends of said L of vertical transfer registers in a longitudinal direction, and said second horizontal transfer register is placed at other ends of said L of vertical transfer registers in a longitudinal direction.

4. A digital camera having an imaging apparatus according to any one of claims 1 to 3.

5. A driving method of an imaging apparatus having a plurality of light receiving elements, L of vertical transfer registers, a first transfer register and a second transfer register, comprising steps of:
(a) reading electric charges generated in said plurality of light receiving elements to said L of vertical transfer registers;
(b) applying electric charges read to M of vertical transfer registers among said L of vertical transfer registers to said first horizontal transfer register; and
(c) applying electric charges read to other N of vertical transfer registers among said L of vertical transfer registers to said second horizontal transfer register.
